(19) United States
(12) Patent Application Publication
(10) Pub. No.: US 2005/0187002 A1
(43) Pub. Date: Aug. 25, 2005

(54) Method and system for playing an electronic video poker game

(76) Inventor: Sal Falciglia SR., Ridgewood, NJ (US)

Correspondence Address: Carter, DeLuca, Farrell & Schmidt, LLP;Suite 225, 445 Broad Hollow Road, Melville, NY, 11747, US

(21) Appl. No.: 11/063,939

(22) Filed: Feb. 23, 2005

Related U.S. Application Data
(60) Provisional application No. 60/546,789, filed on Feb. 23, 2004.
(60) Provisional application No. 60/562,200, filed on Apr. 14, 2004.

(51) Int. Cl. A63F 13/00

(52) U.S. Cl. 463/13

(57) ABSTRACT

An electronic video game is provided which includes a display for displaying a set of game icons by a matrix, and at least one of an icon from a set of matching icons matching the set of game icons and an icon from a set of special icons during each round of the game. The special icons impart predetermined benefits and detriments to a player. At least one processor is provided for determining at least one of a matching condition and a special condition during play of each round. The matching condition is determined if the at least one displayed icon is an icon from the set of matching icons and the at least one displayed icon is matched with a corresponding icon of the set of game icons by the player. The special condition is determined if the at least one displayed icon is an icon from the set of special icons. The at least one processor determines a winning condition based on the matched set of game icons and calculates a score accordingly.

### PRIORITY

The present application claims priority from a U.S. provisional application filed on Apr. 14, 2004 and assigned U.S. Provisional Application Ser. No. 60/562,200 and from a U.S. provisional application filed on Feb. 23, 2004 and assigned U.S. Provisional Application Ser. No. 60/546,789; the contents of both applications is incorporated herein by reference.

### BACKGROUND OF THE INVENTION

1. Field of the Invention

The present disclosure relates generally to games, and more particularly, to a modified electronic video poker card game.

2. Description of the Prior Art

The gaming industry, in particular, gambling casinos, has come to recognize that to sustain long term success it must be constantly innovative in introducing new games and new gambling concepts to the gaming public.

One game of interest over the years is poker. Table and video poker and other casino poker games are well known and enjoy substantial success. With reference to electronic video poker games, in a typical game a player makes a selected wager and initiates the play of the game. The processor of the video poker game is programmed to select from a suitable memory structure containing data representing 52 cards of a deck, data representative of a five card opening holding. These five cards are displayed face up for the player to see. The player can discard some or all of the cards whereupon the processor from the data structure replaces the discarded cards to define a final holding or hand. If the hand corresponds to a pre-determined schedule or table of poker holdings, e.g., a pair of Jacks or better, four-of a-kind, flush, the player is awarded a payoff.

Various attempts have been made to enhance play of poker over the years. There are video poker variations, such as deuces wild, where the deuces of the deck of cards are wild, Joker's wild where a Joker is included in the deck, which is wild as well as Joker/deuces wild games. Further variations have been made over the years. Examples of such attempts are described in U.S. Pat. No. 5,882,260, Marks et al. Marks et al. provides a number of examples of U.S. patent references:

U.S. Pat. No. 4,743,022, Wood, second chance poker method; U.S. Pat. No. 4,948,134, Suttle et al., electronic five card poker game where cards are given to the-players one at a time; U.S. Pat. No. 5,013,049, Tomaszewski, five card poker game where up to two cards are drawn; U.S. Pat. No. 5,118,109, Gumina, instant poker game card; U.S. Pat. No. 5,255,915, Miller, six card, two hand video poker game; U.S. Pat. No. 5,294,128, Marauez, six cards, three hand poker game; U.S. Pat. No. 5,382,025, Sklansky et al., three hands, two card poker game where each player chooses one hand and five communal cards are dealt face up; U.S. Pat. No. 5,407,199, Gumina, interactive video/casino poker game-drawpoker, hold'em poker; U.S. Pat. No. 5,415,404, Joshi et al., multiplay video poker game in which the player's sub-hands are compensated to increase the payoff level of the winning hands; and U.S. Pat. No. 5,431,407, Hofberg et al., casino poker game.

U.S. Pat. No. 5,437,451 to Fulton involves a modified poker game where the player is dealt pairs of cards, where one card is optional and the other mandatory. The player is permitted to exchange at each round the optional card until five cards are selected. The resulting five card hand is then evaluated for payoff against a fairly standard payoff table.

U.S. Pat. No. 5,314,194 to Wolf deals the player seven cards. The player then forms two hands: a five card hand (e.g., a front hand), and a two card hand (e.g., a back hand). The rules for playing this game are quite elaborate, including requiring each player to arrange the hand so that the rank of the back hand is greater than the rank of the front hand.

Each of the prior art attempts at making poker interesting and challenging have been successful to varying degrees. Each provides a poker game that combines the attributes of skill, luck, excitement and simplicity with rapid play.

It is an objective of the present disclosure to provide a modified poker game that combines the attributes of skill, luck, excitement and simplicity with rapid play that is both unique and innovative.

### SUMMARY OF THE INVENTION

The present disclosure provides an embodiment for a computer readable medium comprising a set of computer readable instructions capable of being executed by at least one processor for playing an electronic video poker game in accordance with the present disclosure. The present embodiment provides a set of game icons, preferably representing cards from a standard deck of cards. The game icons are equally separated into a plurality of subsets, such as each subset representing a different suit of the standard deck of cards. A set of special icons is also included, for imparting predetermined benefits and detriments to a player. The special icons include: free spin, which provides at least one additional round in the current game; cherub, which increases the points assigned to each win condition by a given factor; and devil, which negates the current spin or round, resulting in a lost round.

A game board or matrix having a play region is provided for displaying the game icons in predetermined positions. The game board also includes a set of active play positions. In each round, a subset of icons is displayed in the active play positions. The player then moves the displayed icons in the play positions to their corresponding positions in the game board.

Additionally, the game includes a wild icon. The wild icon can be placed or positioned within any of the positions on the game board that are unoccupied at the end of the last round of the game. An interface is provided for enabling a player to select which position on the game board will be occupied by each acquired wild icon. Placement of the wild icons is performed with the goal of creating one or more winning conditions. The user interface further enables the player to interact with the game, e.g., initiating game play, indicating a wager amount, ending game play and cashing out any accumulated winnings and/or credits. A win condition is determined based on a predetermined set of possible winning game icon configurations modeled on standard poker hands. A score is calculated based on the determined win condition and points or winnings assigned based on a predetermined pay table.

In one embodiment of the present disclosure, all the special icons, when any are displayed, occupy one of the active play positions, while in an alternate embodiment, a special icon, such as a free spin, is overlaid on another game icon such that two game icons are displayed or represented by one active play position. Preferably, the game in accordance with both embodiments of the present disclosure is a bonus or secondary game which is initiated by a processor of a casino-type game machine (e.g., slot machine), a video poker game machine, etc. upon a player meeting predetermined criteria or a predetermined score in a primary game.

### BRIEF DESCRIPTION OF THE DRAWINGS

These and other features, aspects, and advantages of the present disclosure will become better understood with regard to the following description, appended claims, and accompanying drawings wherein:

FIGS. 1-8 illustrate an embodiment of an electronic video poker game, in accordance with the present disclosure, in various stages of game play;

FIG. 9 is a pay table for the electronic video poker game shown in FIGS. 1-8;

FIGS. 10-25 illustrate an alternate embodiment of an electronic video poker game, in accordance with the present disclosure, in various stages of game play; and

FIG. 26 is a pay table for the electronic video poker game shown in FIGS. 10-26.

### DESCRIPTION OF THE PREFERRED EMBODIMENTS

The present disclosure provides a system and method for playing an electronic video poker card game in which the player has at least one turn or spin to get as many royal flushes, four-of-a-kinds, and three-of-a-kinds on a matrix of playing cards. Preferably, the player has four turns or spins. The present disclosure further provides a computer readable medium storing a set of computer readable instructions capable of being executed by at least one processor for playing then electronic video poker game in accordance with the present disclosure.

The electronic video poker card game is preferably provided in the form of a stand-alone or bonus casino-type machine, which accepts money or deducts money from a credit line. It is contemplated that the electronic video poker card game can also be provided as computer software for playing the game on a personal computer, a PDA, or other computing device. It is also contemplated that the software can be stored at a remote server which is accessible via a network, such as the Internet, for enabling players to play the game over a network connection without downloading the software.

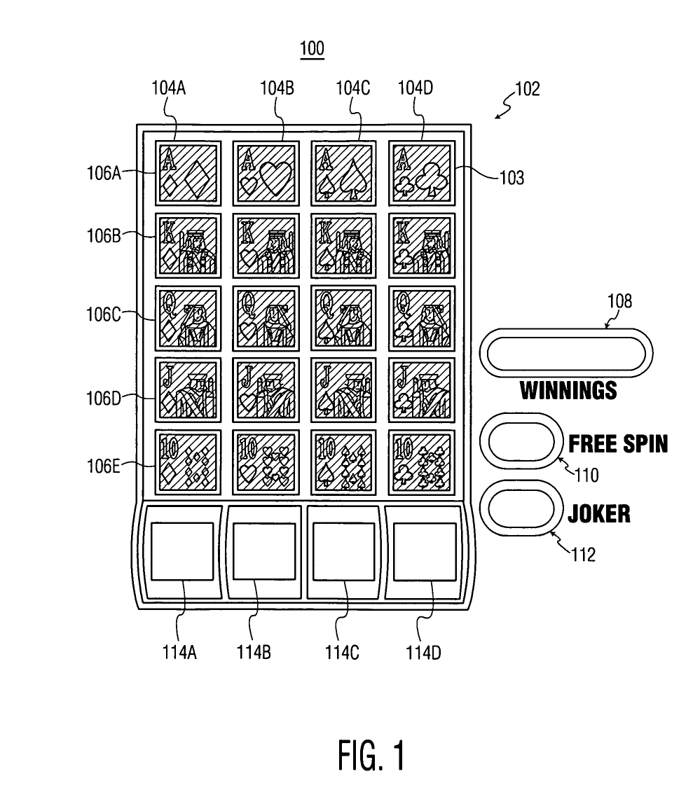

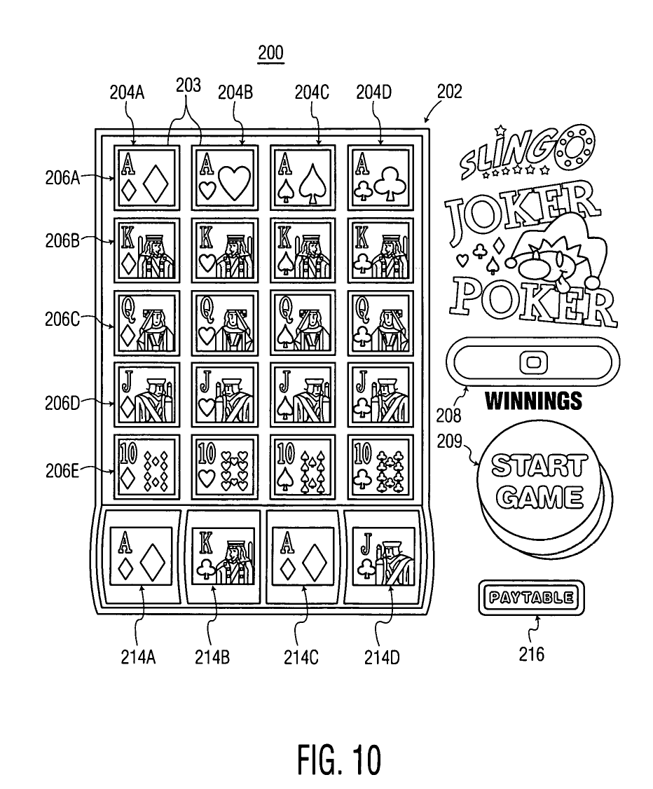

Exemplary methods of playing two different embodiments of the video poker game of the present disclosure and preferred embodiments of the inventive system will now be described. Prior to beginning play of the game, a graphical user interface of the video poker game is displayed on a display of the casino-type machine. Exemplary graphical user interfaces are shown by FIGS. 1 and 10 and designated generally by reference numerals 100 and 200, respectively. These are the main graphical user interfaces used throughout the duration of the game of a first embodiment and an alternate embodiment, respectively, as further described below and shown by the remaining figures.

In the first embodiment, the game is played with a 24-card deck of cards. The 24 cards contain cards from a standard deck of poker playing cards (four aces, four kings, four queens, four jacks, four tens, and one Joker) and three additional cards (one Free Spin card, one Devil card and one Cherub card). Each card of the four aces, four kings, four queens, four jacks, and four tens represents one of the four suits, i.e., diamonds, hearts, spades and clubs. These cards are displayed on a game board or matrix 102 of the graphical user interface 100 as shown by FIG. 1. The matrix 102 has a plurality of windows 103 arranged as four columns 104A-D and five rows 106A-E. The aces are displayed by the first row 106A of windows 103, the kings are displayed by the second row 106B of windows 103, the queens are displayed by the third row 106C of windows 103, the jacks are displayed by the fourth row 106D of windows 103, and the tens are displayed by the fifth row 106E of windows 103.

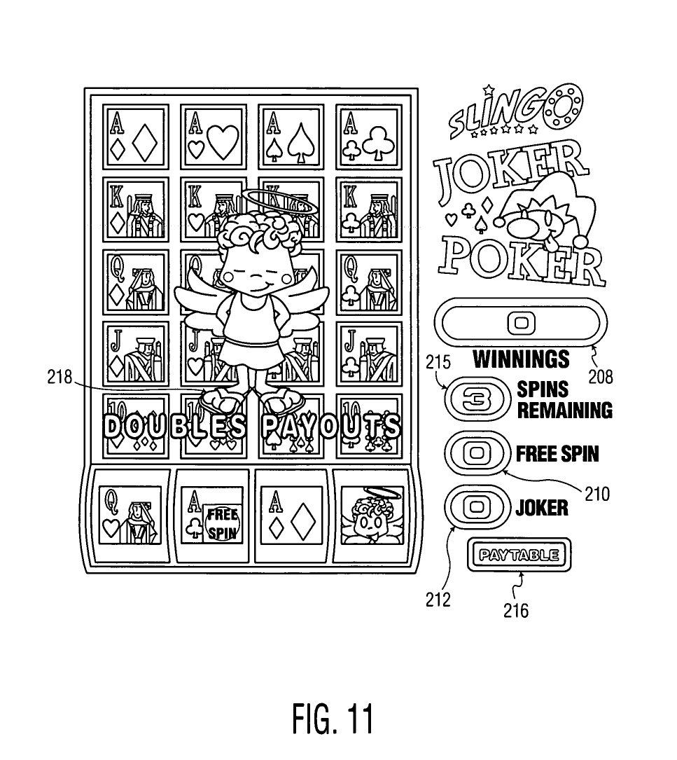

In the alternate embodiment, the game is played with a 23-card deck of cards which include the same cards as the first embodiment except the Free Spin card. In this embodiment, one of the playing cards randomly has a free spin attached to it, which is graphically indicated to the player by overlaying the card, for example, with the words “FREE SPIN.” (See FIG. 11) When that card is matched with the corresponding card in the matrix 102′, the player is awarded the free spin.

The graphical user interface 100 further displays a window labeled “Winnings” 108 for displaying the player's winnings, a window labeled “Free Spin” 110 for indicating if a free spin has been awarded to the player, and a window labeled “Joker” 112 for indicating if the Joker card has been awarded to the player.

The graphical user interface 100 also displays four windows 114A-D. Each window 114 is displayed below a corresponding column 104 of the matrix 102. It is contemplated that the windows 114A-D can be displayed at a different location of the graphical user interface 100, such as above the matrix 102, on the side of the matrix 102, above the window 108, etc.

After each spin, each of the windows 114A-D displays one of the cards of the 24-card deck (or 23-card deck if playing the alternate embodiment) without any duplication. Without any duplication means that if, for example, the ten of hearts is displayed by window 114A after a particular spin, this card cannot be displayed by windows 114B-D after that same spin (also this card cannot be redisplayed by windows 114A-D after any subsequent spin, since this card matches a card displayed by the matrix 102 as further described below).

If the cards displayed by the windows 114A-D match a card displayed by the matrix 102, those cards are removed from the 24-card deck (or 23-card deck if playing the alternate embodiment) and cannot be redisplayed after subsequent spins. Therefore, if after the first spin, the ten of hearts is displayed by window 114A, the king of clubs is displayed by window 114B, the Joker is displayed by window 114C, and the queen of hearts is displayed by window 114D, the ten of hearts, the king of clubs and the queen of hearts are removed from the deck, since these cards match a card displayed by the matrix 102. Therefore, these cards, i.e., the ten of hearts, the king of clubs and the queen of hearts, cannot be redisplayed after the subsequent spins.

Also, the corresponding cards displayed by the matrix 102, i.e., the ten of hearts, the king of clubs and the queen of hearts, are highlighted on the matrix 102 or some indication is made (e.g., blacked-out, overlaid with lines or some symbol (cross-hair, X), etc.) to indicate that the player has matched these cards. Preferably, the windows 103 of the matrix 102 at the start of the game are gray or shaded and the windows 103 are lit up or highlighted after their displayed card is matched with a card displayed by the windows 114A-D.

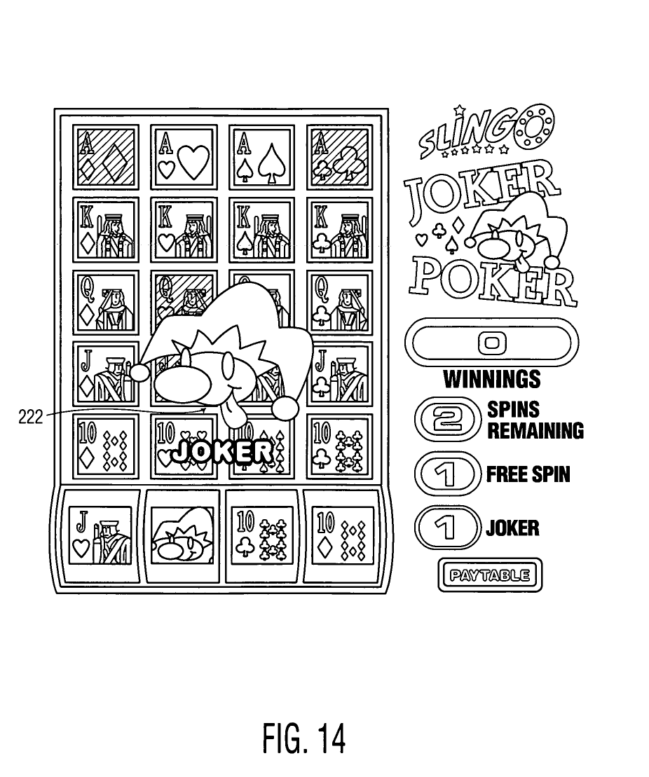

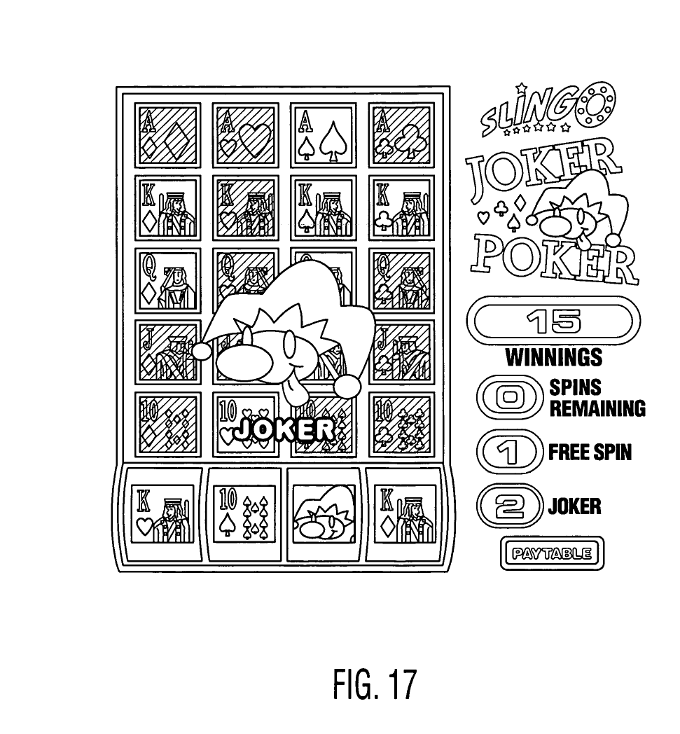

Also, in the above example, since the Joker card is displayed by window 114C, the Joker card is removed from the deck and the Joker window 112 indicates that the player has been awarded the Joker card. The Joker card is kept aside until all four spins have been played. Then the player can place the Joker card anywhere in the matrix 102 to fill in any possible royal flush, four-of-a-kind, and/or three-of-a-kind to meet the game's objective which is, as indicated above, to get as many royal flushes, four-of-a-kinds and three-of-a-kinds. In the alternate embodiment, the Joker card is not removed from the deck after first being obtained. In the alternate embodiment, the Joker card is removed from the deck after being obtained twice, such that in this embodiment the player can obtain the Joker card two times (see FIGS. 14 and 17).

If, in the above example, one of the windows 114A-D displayed the Free Spin card, the Free Spin window 110 will indicate that the player has been awarded a free spin and the Free Spin card would be removed from the deck. The player would then be able to use the free spin after all four spins have been played.

If the Devil card is displayed by any of the windows 114A-D after a spin, the Devil card negates the outcomes of that spin. Therefore, if the Devil card is displayed after a spin, the remaining cards displayed by the matrix 102 which match cards displayed by the windows 114A-D are not highlighted and the cards displayed by the windows 114A-D are removed from the deck.

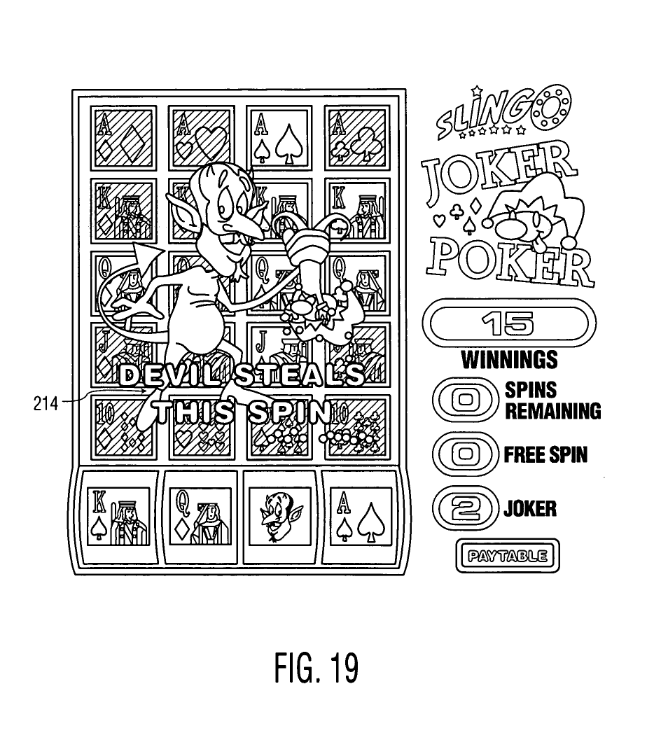

This is also the case with the alternate embodiment (see FIG. 19); that is, if the Devil card is displayed after a spin, the remaining cards displayed by the matrix which match cards displayed by the windows are not highlighted and the cards displayed by the windows are removed from the deck (unless the Cherub card is also displayed, since the Cherub card negates the Devil card as further described below). It is also contemplated in a still alternate embodiment to remove the Joker card and the Free Spin card from the deck if they are concurrently displayed with the Devil card without awarding the Joker and free spin to the player (unless the Cherub card is also displayed).

If the Cherub card is displayed by any of the windows 114A-D after a spin (see FIG. 11 indicative of the alternate embodiment), the Cherub card doubles the player's winnings for that spin only, if the player attains a round robin, a royal flush, a four-of-a-kind and/or a three-of-a-kind for that spin only.

Given the following winning payouts: royal flush, 50 points; four-of-a-kind, 25 points; three-of-a-kind, 10 points; and completing a round robin, 1,000 points plus awarding of a progressive jackpot, if, for example, a Cherub card is displayed by one of the windows 114A-D after a spin and the player attains a royal flush after that spin, the player is awarded 100 points instead of 50 points.

In the alternate embodiment, the winning payout is preferably as follows: royal flush, 15 points; four-of-a-kind, 10 points; three-of-a-kind, 5 points; completing a round robin, 200 points; and highlighting the entire matrix 102 (cover all), 1135 points. It is contemplated that if the player highlights the entire matrix 102, the player is also awarded a progressive jackpot where a plurality of gaming machines or computers are networked as known in the art. It is further contemplated that points for the above-described payouts can refer to dollars or other monetary units.

If the Devil card and the Cherub card are displayed after a spin, then the Cherub card negates the Devil card and the other two cards are in play for matching corresponding cards on the matrix 102. If one of the other two cards, or both of the other two cards, correspond to the Free Spin card and/or the Joker card, the player is awarded the free spin and the Joker for use after the fourth spin. If the player has been awarded both, the free spin is played first prior to the Joker. However, it is contemplated that the game can be designed such that the Joker is played prior to the free spin.

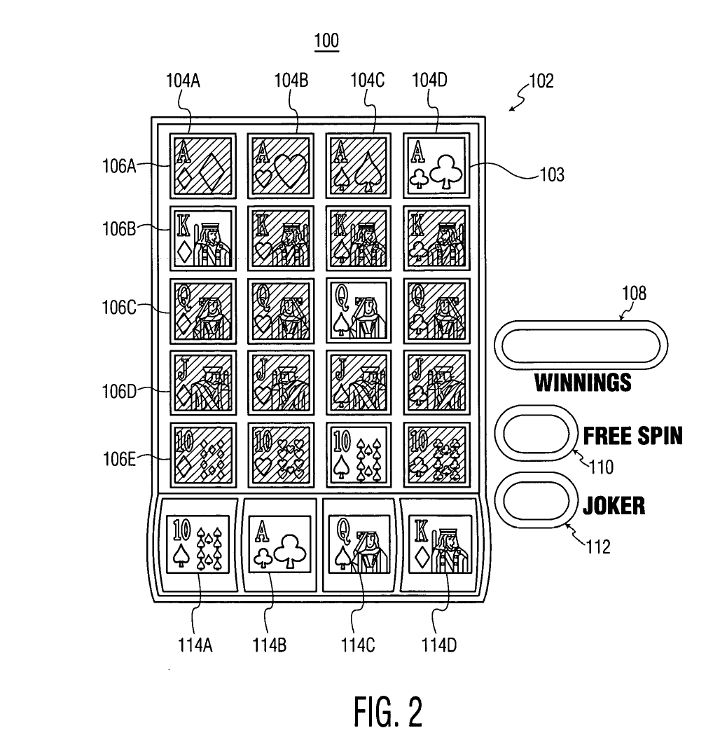

An exemplary play of the game of the first embodiment of the present disclosure will now be described with reference to FIGS. 2-8. To start playing the game, the player makes an initial wager by depositing coins, paper money, etc. into a slot or money receiving device of the casino-type machine. The player can then initiate the first spin by pressing a Spin button or pulling a lever of the casino-type machine.

FIG. 2 illustrates the graphical user interface 100 after the first spin where windows 114A-D respectively display a ten of spades, an ace of clubs, a queen of spades, and a king of diamonds. The corresponding cards on the matrix 102 have been highlighted to indicate that the player has matched these cards. These cards are removed from the 24-card deck prior to the player initiating the second spin. Since none of the windows 114A-D display the Free Spin card or the Joker card, windows 110 and 112 remain blank. Also, since the player has not attained a royal flush, a four-of-a-kind or a three-of-a-kind, the player is not awarded any points and the Winnings window 108 remains blank or displays a zero.

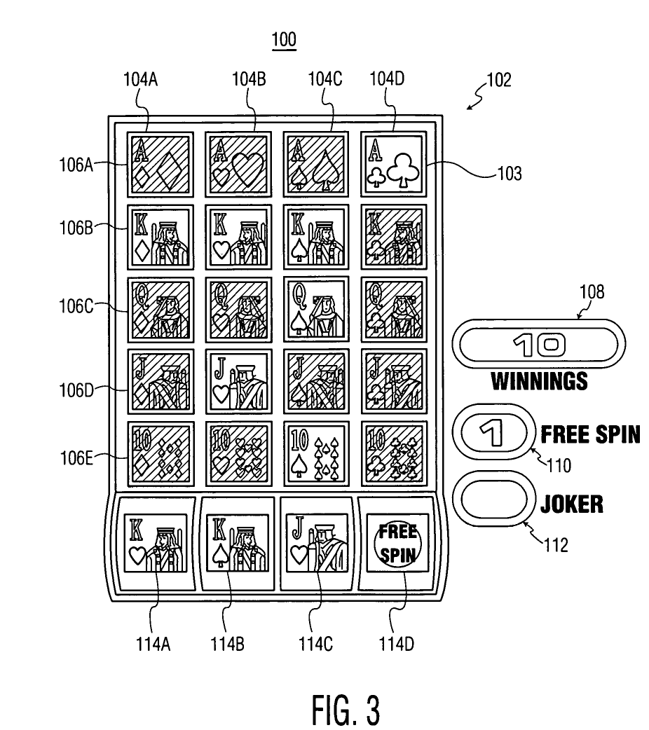

FIG. 3 illustrates the graphical user interface 100 after the second spin where windows 114A-D respectively display a king of hearts, a king of spades, a jack of hearts, and the Free Spin card. The corresponding cards on the matrix 102 have been highlighted to indicate that the player has matched these cards. These cards are removed from the deck prior to the player initiating the third spin. Since window 114D displays the Free Spin card, window 110 displays “FS” to indicate the player has been awarded a free spin. After this spin, the player has attained a three-of-a-kind (three kings) and the player is awarded ten points which are displayed by the Winnings window 108.

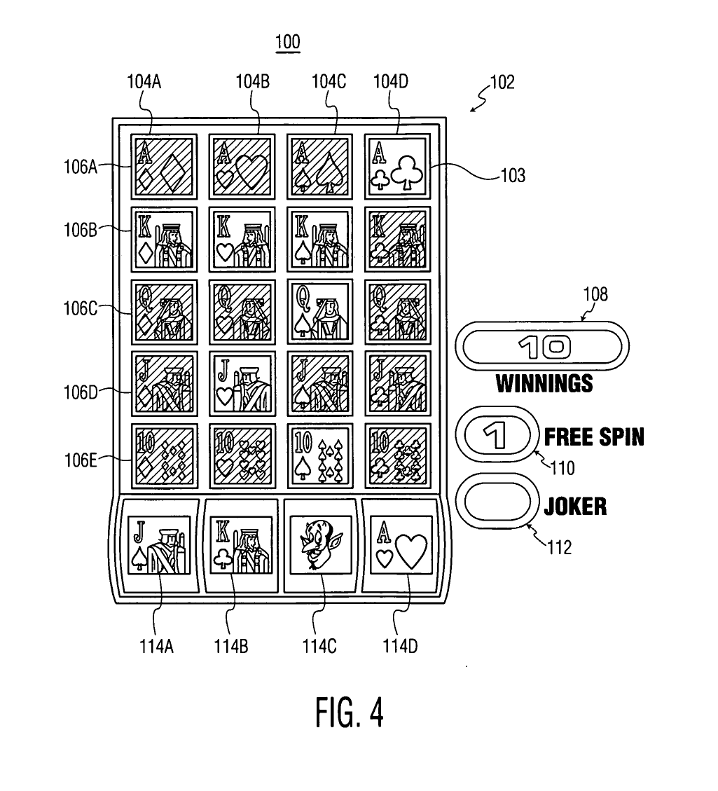

FIG. 4 illustrates the graphical user interface 100 after the third spin where windows 114A-D respectively display a jack of spades, a king of clubs, the Devil card, and an ace of hearts. The corresponding cards on the matrix 102 have not been highlighted, since the Devil card is displayed by window 114C thereby negating the outcomes of the third spin. Accordingly, the matrix 102 is identical to the matrix 102 displayed after the second spin (FIG. 2). The cards displayed by windows 114A-D are removed from the deck.

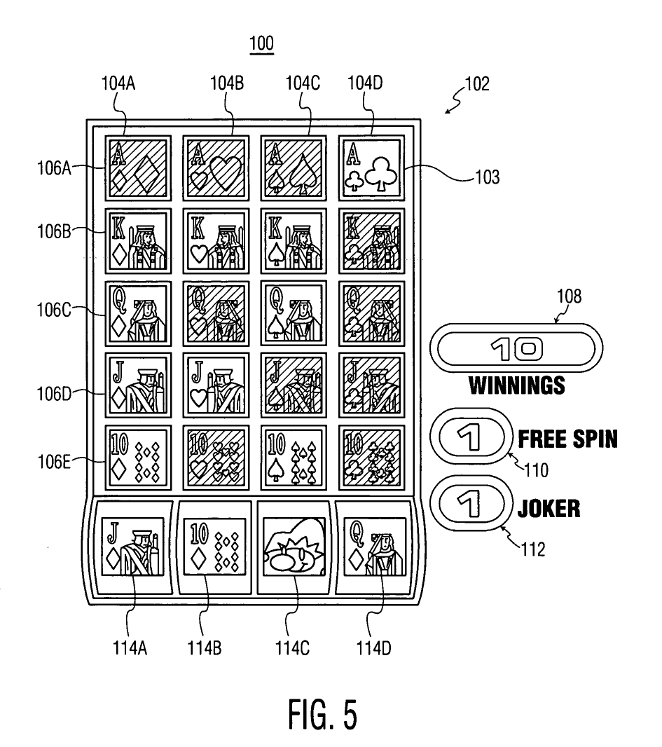

FIG. 5 illustrates the graphical user interface 100 after the fourth spin where windows 114A-D respectively display a jack of diamonds, a ten of diamonds, the Joker card, and a queen of diamonds. The corresponding cards on the matrix 102 have been highlighted to indicate that the player has matched these cards. These cards are removed from the deck prior to the player initiating the free spin awarded after the second spin. Since window 114C displays the Joker card, window 112 displays “J” to indicate the player has been awarded the Joker card. After this spin, the player has not attained any additional points, and the Winnings window 108 continues to display 10 points.

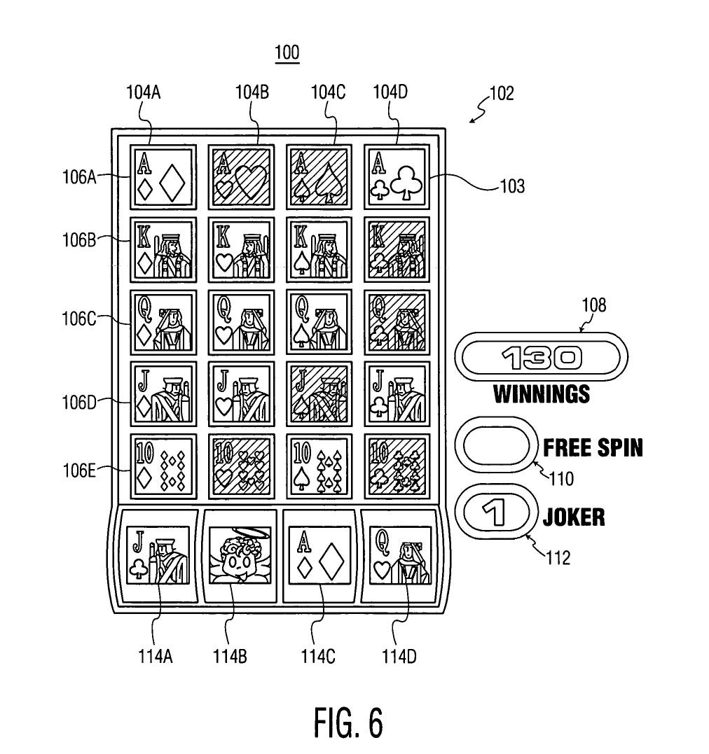

FIG. 6 illustrates the graphical user interface 100 after the free spin where windows 114A-D respectively display a jack of clubs, the Cherub card, an ace of diamonds, and a queen of hearts. The corresponding cards on the matrix 102 have been highlighted to indicate that the player has matched these cards. Since window 114B displays the Cherub card, the points attained following the free spin due to attaining a royal flush and/or four-of-a-kind are doubled. After the free spin, the player has attained two three-of-a-kinds (three queens and three jacks) and the player is awarded twenty points; the player has also attained a royal flush and the player is awarded 50 points, which are doubled due to the Cherub card to 100 points. Therefore, the total points awarded to the player after the free spin is 120 points and hence, the Winnings window 108 displays 130 points.

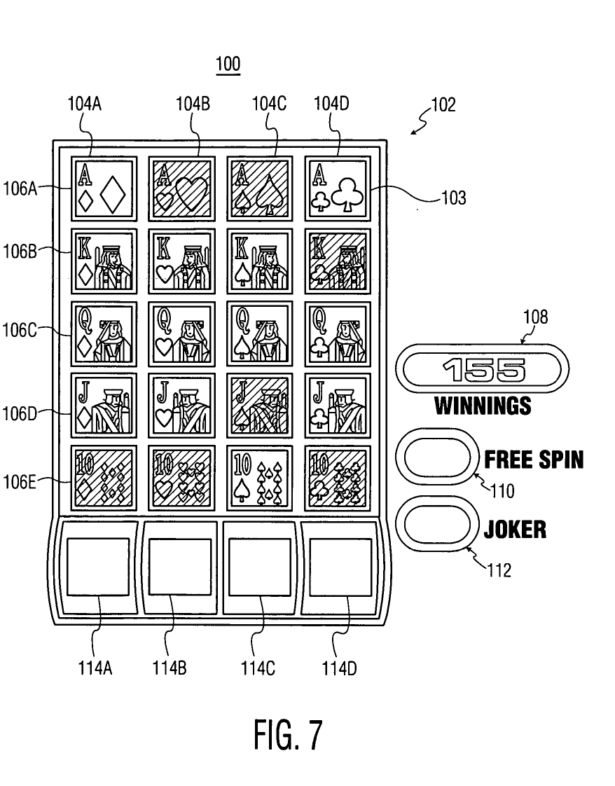

FIG. 7 illustrates the graphical user interface 100 after the player has used the Joker card to black-out the queen of clubs on the matrix 102 to attain a four-of-a-kind and an additional 25 points to end up with a total of 155 points which are displayed by the Winnings window 108.

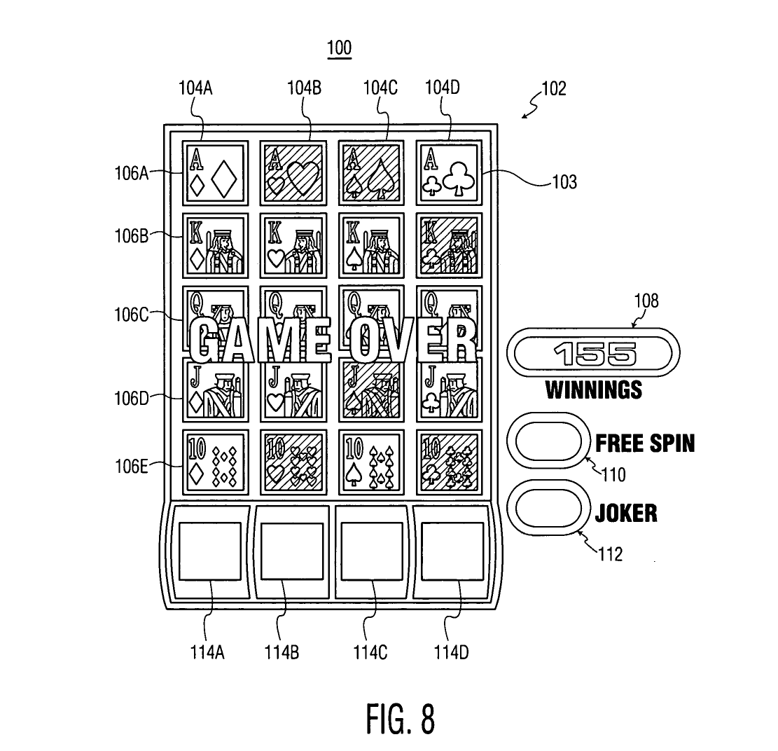

FIG. 8 illustrates the graphical user interface 100 overlaid with a “GAME OVER” message to indicate the end of the game.

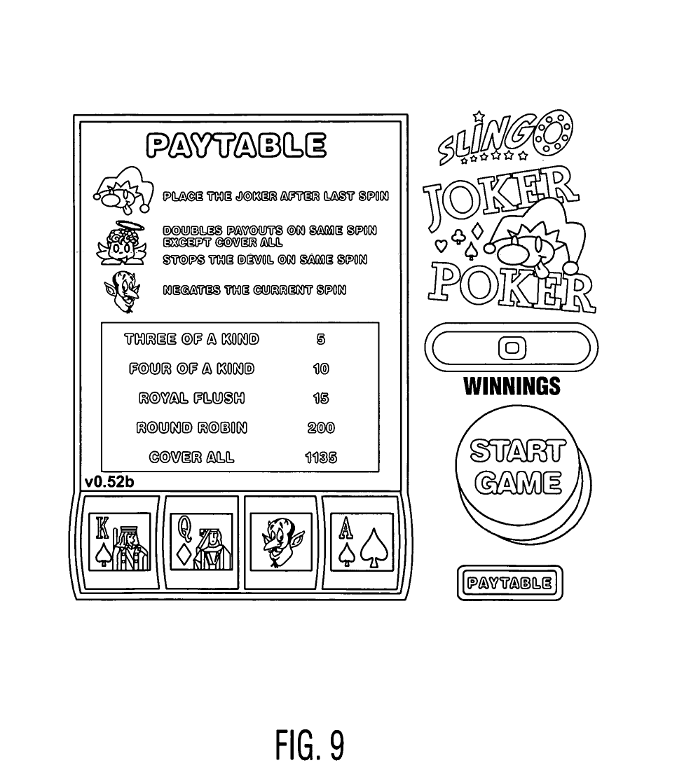

Even though the FIGS. 1-8 display or indicate the various cards of the deck by using abbreviations, it is desirable to implement the game by displaying the cards as they are generally illustrated or presented in a standard deck of poker playing cards and to use illustrations or icons for the Devil, Joker and Cherub (see FIGS. 9-26).

An exemplary play of the alternate embodiment of the present disclosure is shown by FIGS. 10-26. FIG. 10 displays a graphical user interface 200 prior to initiation of the game. The graphical user interface 200 includes a matrix 202 having a plurality of windows 203 arranged as four columns 204A-D and five rows 206A-E. The aces are displayed by the first row 206A of windows 203, the kings are displayed by the second row 206B of windows 203, the queens are displayed by the third row 206C of windows 203, the jacks are displayed by the fourth row 206D of windows 203, and the tens are displayed by the fifth row 206E of windows 203.

The graphical user interface 200 further displays a window labeled “WINNINGS” 208 for displaying the player's winnings, a window labeled “START GAME” 209, a window labeled “FREE SPIN” 210 (see FIG. 11) for indicating if one or more free spins have been awarded to the player, a window labeled “JOKER” 212 for indicating if the Joker card has been awarded to the player, and a window labeled “SPINS REMAINING” 215 for indicating how many spins are left.

The graphical user interface 200 also displays four windows 214A-D. Each window 214 is displayed below a corresponding column 204 of the matrix 202. It is contemplated that the windows 214A-D can be displayed at a different location of the graphical user interface 200, such as above the matrix 202, on the side of the matrix 202, above the window 208, etc. A window labeled “PAYTABLE” 216 is also displayed by the graphical user interface 200 for accessing the pay table shown by FIG. 9.

To start the game, the player clicks on the window labeled “START GAME” 209 or performs some other action (like pulling a lever on a gaming machine). After starting the game, the first spin of the four spins is played and the windows 214A-D display one of the cards of the 23-card deck without any duplication as mentioned above. The only exception where a window 214A-D displays more than one card is if the window displays the Free Spin card as shown by window 214B in FIGS. 11-13. Such a window displays a card from a standard deck of cards (in this case, an Ace of clubs) and the Free Spin card for a total of two cards.

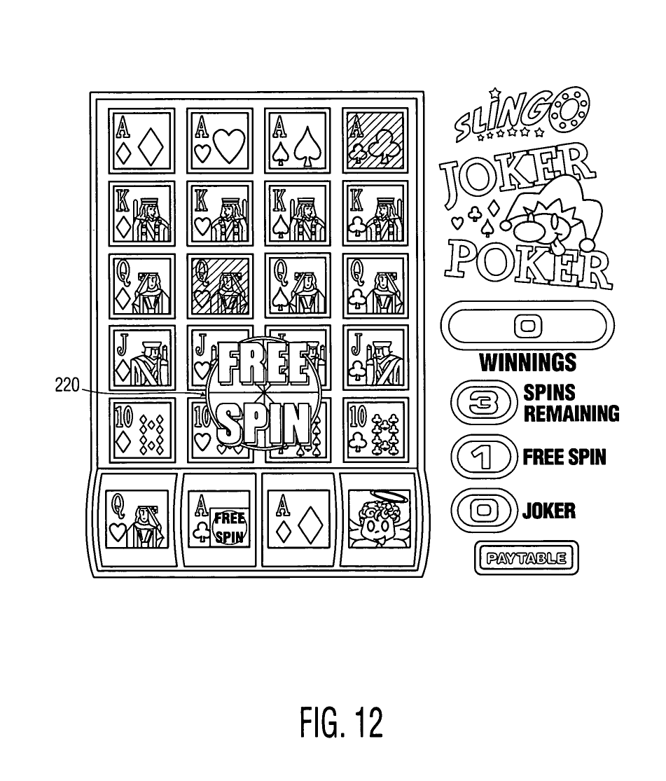

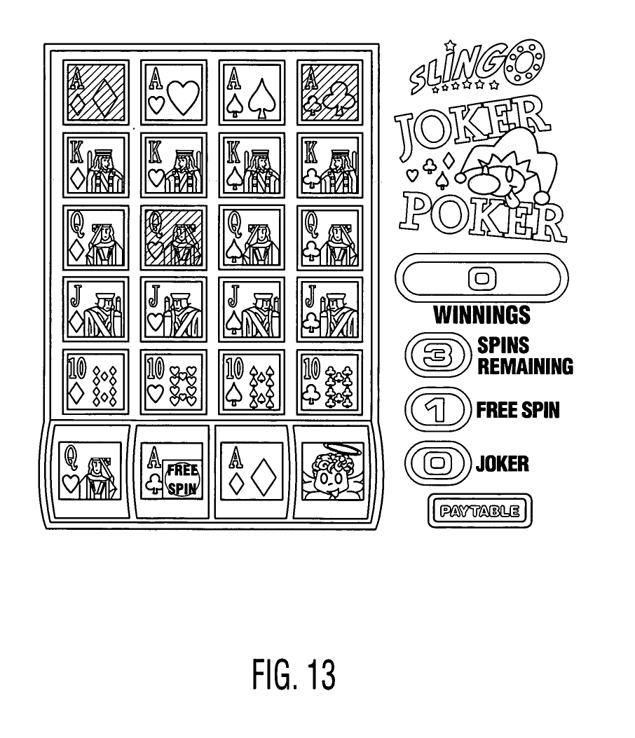

With further reference to FIGS. 11-13, after the first spin, the player attains a queen of hearts in window 214A, an ace of clubs in window 214B overlaid with the Free Spin card, an ace of diamonds in window 214C and the Cherub card in window 214D. The corresponding cards are blacked-out on the matrix 202 (see FIGS. 12 and 13) and removed from the 23-card deck (except the Free Spin card).

Since the Cherub card is attained after the first spin, the point value associated with any royal flush and/or four-of-a-kind attained after the first spin is doubled. An icon 218 (see FIG. 11) is displayed by the graphical user interface 200 indicating that the payout is doubled. Another icon 220 (see FIG. 12) is also displayed indicating that the Free Spin card has been revealed and the window labeled “FREE SPIN” 210 is incremented by one to show that the player has attained a free spin.

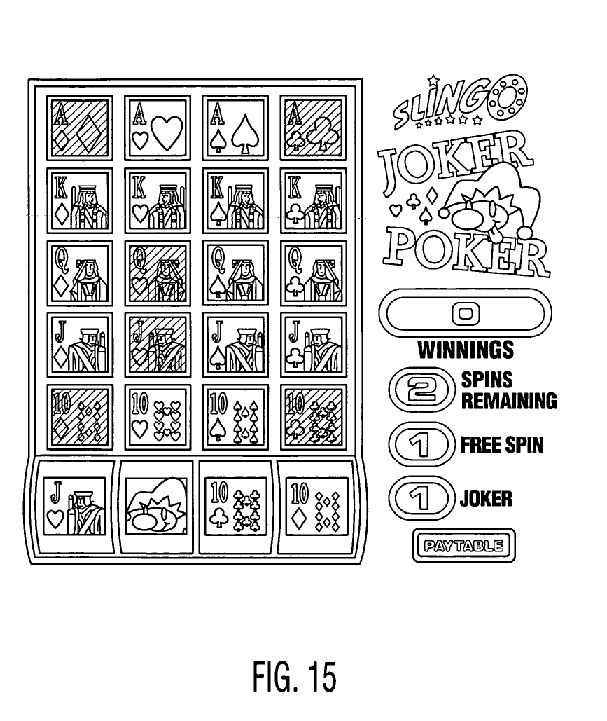

With reference to FIGS. 14 and 15, after the second spin, the player attains a jack of hearts in window 214A, the Joker card in window 214B, a ten of clubs in window 214C and a ten of diamonds in window 214D. The corresponding cards are blacked-out on the matrix 202 and removed from the deck (except the Joker card).

Since the Joker card is attained after the second spin, an icon 222 (see FIG. 14) is displayed by the graphical user interface 200 indicating that the Joker card has been revealed and the window labeled “JOKER” 210 is incremented by one to show that the player has attained the Joker card.

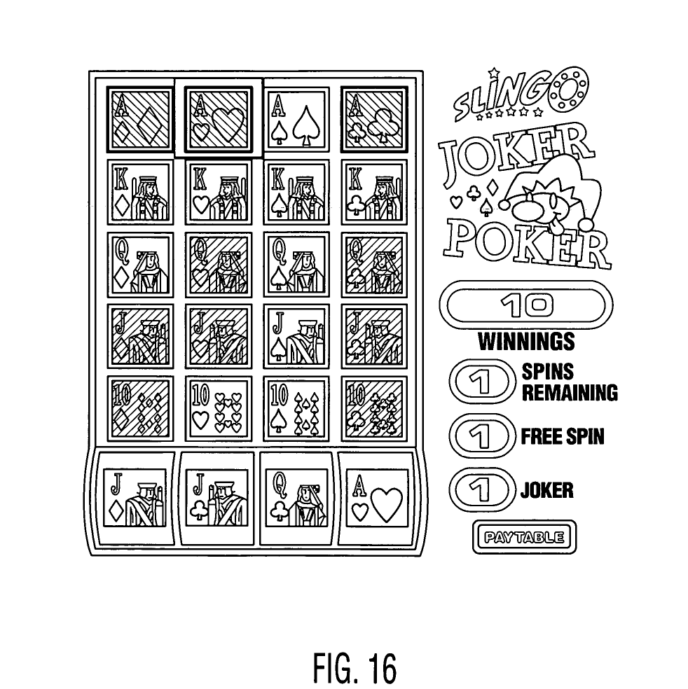

With reference to FIG. 16, after the third spin, the player attains a jack of diamonds in window 214A, a jack of clubs in window 214B, a queen of clubs in window 214C and an ace of hearts in window 214D. The corresponding cards are blacked-out on the matrix 202 and removed from the deck. After the third spin, the player also attains two three-of-a-kinds (three aces in row 206A and three jacks in row 206D) and is awarded ten points as indicated by the window labeled “WINNINGS” 208.

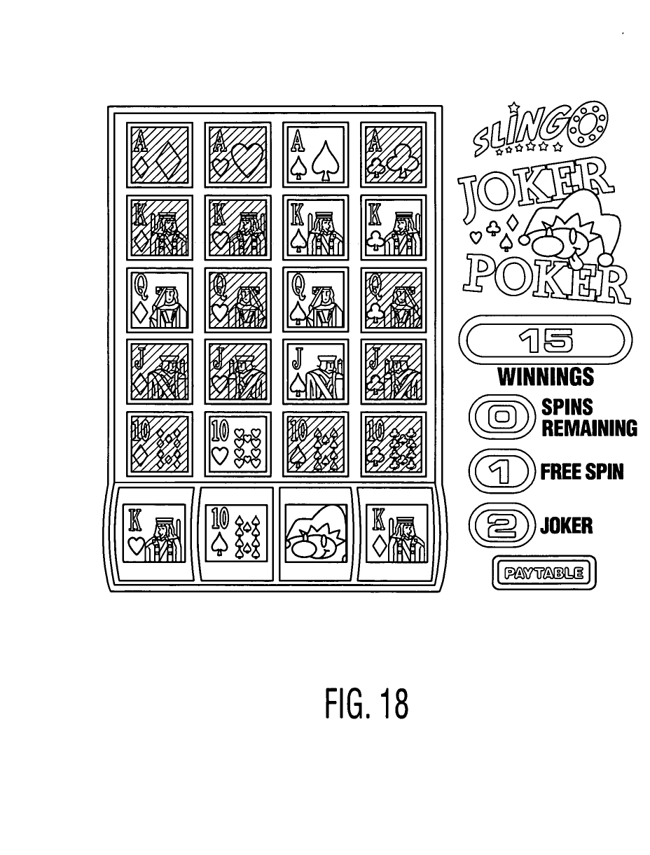

With reference to FIGS. 17 and 18, after the fourth spin, the player attains a king of hearts in window 214A, a ten of spades in window 214B, the Joker card in window 214C and a king of diamonds in window 214D. The corresponding cards are blacked-out on the matrix 202 and removed from the deck (including the Joker card).

Since the Joker card is attained after the fourth spin, the icon 222 (see FIG. 17) is redisplayed by the graphical user interface 200 indicating that the Joker card has been revealed once again and the window labeled “JOKER” 210 is incremented by one to show that the player has re-attained the Joker card. After the fourth spin, the player also attains one three-of-a-kind (three tens in row 206E) and is awarded five points to bring the total number of points to fifteen as indicated by the window labeled “WINNINGS” 208.

With reference to FIG. 19, during play of the free spin, the Devil card is revealed in window 214C and the spin is negated. An icon 224 is displayed by the graphical user interface 200 indicating that the Devil card has been revealed and that the spin is negated.

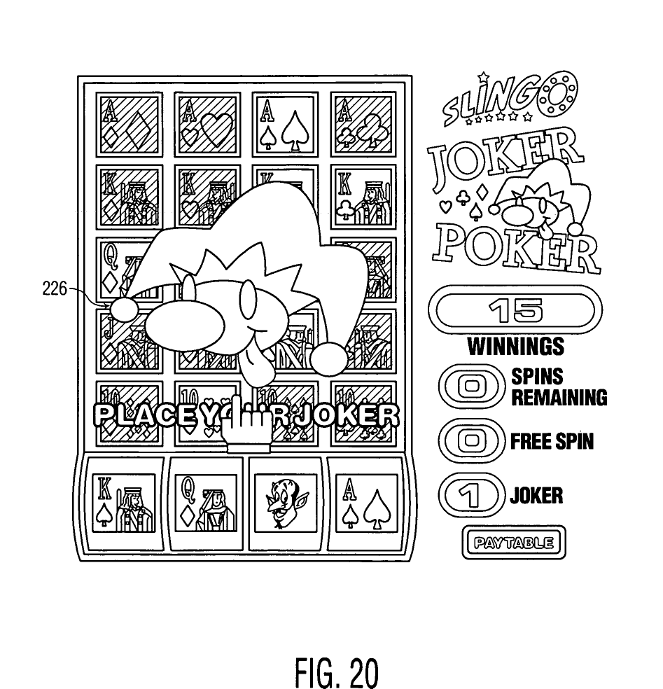

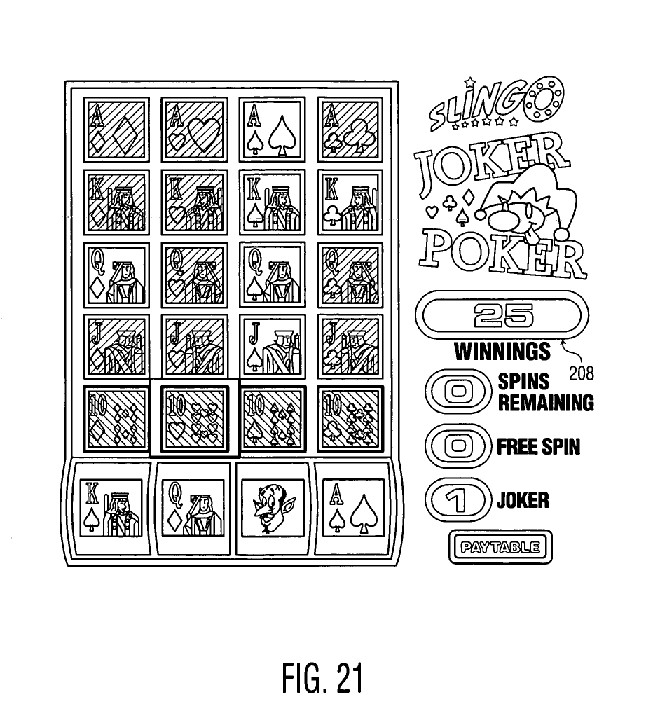

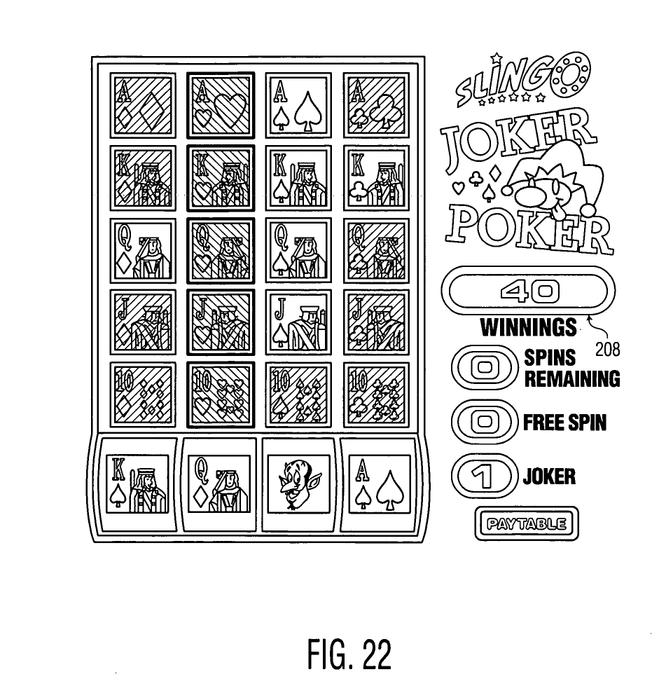

After the free spin is played, the player is then given the opportunity to place the first of the two Jokers on the matrix 202 (see FIG. 20). An icon 226 is displayed by the graphical user interface 200 notifying the player to place the Joker on the matrix 202. After the Joker is placed on the matrix 202 (second window 103 from the left in row 206E), the player attains a four-of-a-kind (four tens in row 206E) and is awarded ten points to bring the total number of points awarded to twenty-five as shown by the window labeled “WINNINGS” 208 in FIG. 21. The player also attains a royal flush (column 204B) and is awarded fifteen points to bring the total number of points awarded to forty as shown by the window labeled “WINNINGS” 208 in FIG. 22.

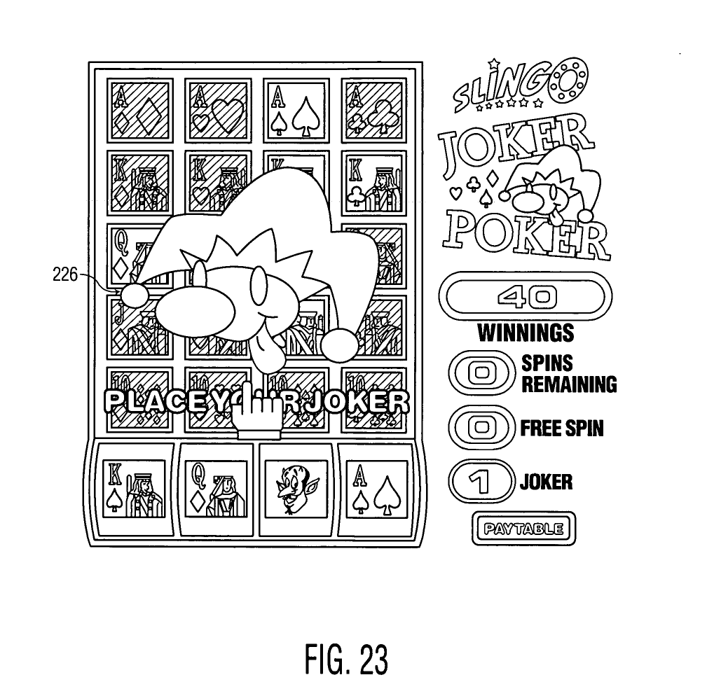

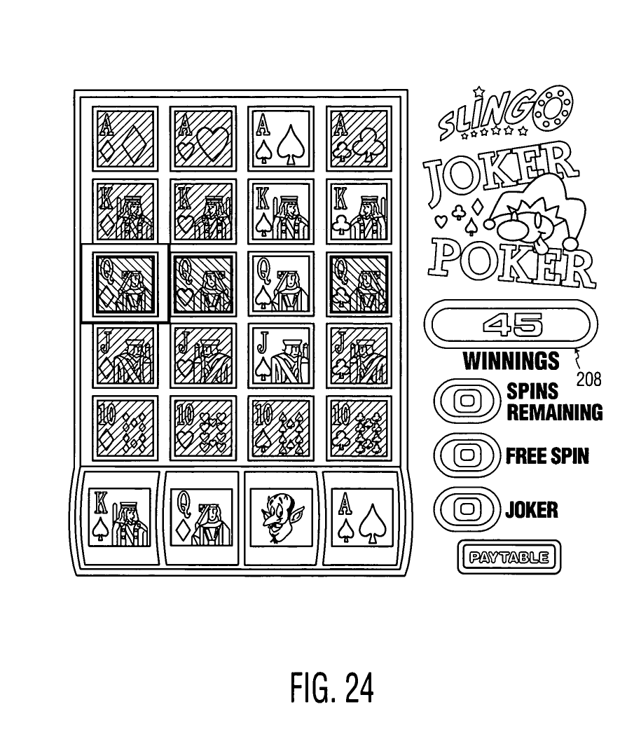

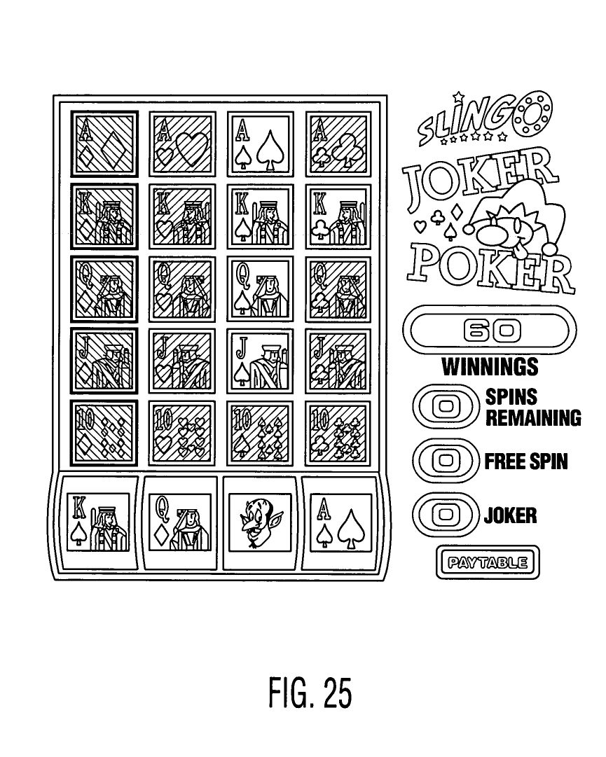

After the first Joker is placed on the matrix 202, the player is then given the opportunity to place the second of the two Jokers on the matrix 202 (see FIG. 23). The icon 226 is redisplayed by the graphical user interface 200 notifying the player to place the Joker on the matrix 202. After the second Joker is placed on the matrix 202 (leftmost window 103 in row 206C), the player attains a three-of-a-kind (three queens in row 206C) and is awarded five points to bring the total number of points awarded to forty-five as shown by the window labeled “WINNINGS” 208 in FIG. 24. The player also attains a royal flush (column 204A) and is awarded fifteen points to bring the total number of points awarded to sixty as shown by the window labeled “WINNINGS” 208 in FIG. 25.

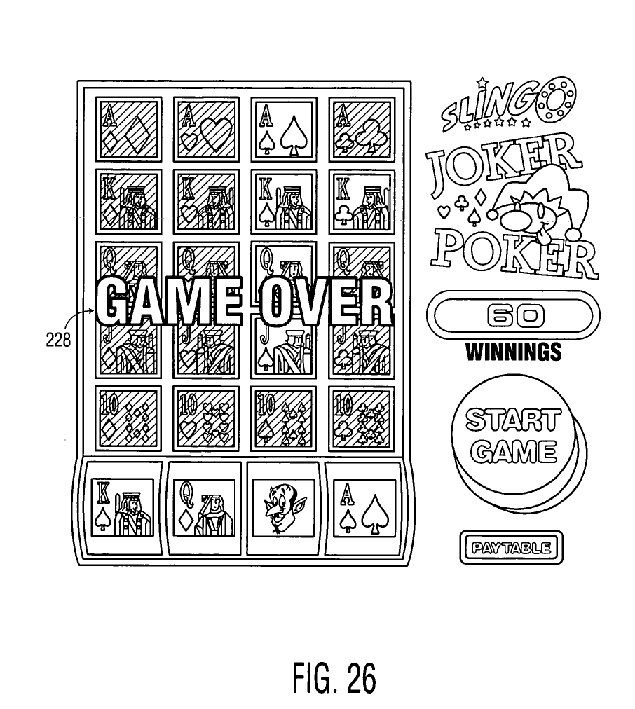

After placing the second Joker on the matrix 202, the game is over and a GAME OVER icon 228 is displayed by the graphical user interface 200 as shown by FIG. 26.

Preferably, the game in accordance with both embodiments of the present disclosure is a bonus or secondary game which is initiated by a processor of the casino-type game machine (e.g., slot machine), a video poker game machine, etc. upon a player meeting predetermined criteria or a predetermined score in a primary game.

The described embodiments of the present disclosure are intended to be illustrative rather than restrictive, and are not intended to represent every embodiment of the present disclosure. Various modifications and variations can be made without departing from the spirit or scope of the present disclosure as set forth in the following claims both literally and in equivalents recognized in law.

1. A method for playing a game comprising the steps of:
displaying a set of game icons, each game icon being displayed by a corresponding position of a matrix;
displaying at least one of an icon from a set of matching icons matching the set of game icons and an icon from a set of special icons during each round of the game, said special icons imparting predetermined benefits and detriments to a player;
determining at least one of a matching condition and a special condition during play of each round, where said matching condition is determined if the at least one displayed icon is an icon from the set of matching icons and the at least one displayed icon is matched with a corresponding icon of the set of game icons by the player, and said special condition is determined if the at least one displayed icon is an icon from the set of special icons;
determining a winning condition if at least three icons from the set of game icons displayed by at least one of a row and column of the matrix are matched during play of a single round or a combination of rounds; and
calculating a score based on the determined winning condition.

2. The method according to claim 1, wherein one of the icons of the set of special icons includes a wild icon for matching any displayed and unmatched icon from the set of game icons.

3. The method according to claim 2, further comprising the step of providing the player the opportunity to match a displayed icon from the set of game icons using the wild icon.

4. The method according to claim 1, further comprising the steps of:
determining at least one of a predetermined benefit and detriment to be imparted to the player if the at least one displayed icon is an icon from the set of special icons; and
performing the at least one of the predetermined benefit and detriment.

5. The method according to claim 4, wherein the predetermined benefits and detriments are selected from the group consisting of doubling a player's winnings during a single round, negating any winnings during the single round, canceling any detriments to the player during the single round, and awarding a free round of play to the player.

6. The method according to claim 1, wherein the set of game icons and the set of matching icons are selected from the group consisting of a standard deck of playing cards.

7. The method according to claim 6, wherein the set of game icons and the set of matching icons each include aces, kings, queens, jacks and tens corresponding to the suits of diamonds, hearts, spades and clubs.

8. The method according to claim 7, wherein the step of determining a calculating a score includes the step of determining if the player matched three game icons of the same kind (three-of-a-kind); if the player matched four game icons of the same kind (four-of-a-kind); and if the player matched four game icons which include a ten, a jack, a queen, a king and an ace of the same suit.

9. An electronic video game comprising:
a display for displaying a set of game icons, each game icon being displayed by a corresponding position of a matrix, and at least one of an icon from a set of matching icons matching the set of game icons and an icon from a set of special icons during each round of the game, said special icons imparting predetermined benefits and detriments to a player; and
at least one processor for determining at least one of a matching condition and a special condition during play of each round, where said matching condition is determined if the at least one displayed icon is an icon from the set of matching icons and the at least one displayed icon is matched with a corresponding icon of the set of game icons by the player, and said special condition is determined if the at least one displayed icon is an icon from the set of special icons;
said at least one processor further determining a winning condition if at least three icons from the set of game icons displayed by at least one of a row and column of the matrix are matched during play of a single round or a combination of rounds; and
said at least one processor calculating a score based on the determined winning condition.

10. The electronic video game according to claim 9, wherein one of the icons of the set of special icons includes a wild icon for matching any displayed and unmatched icon from the set of game icons.

11. The electronic video game according to claim 10, wherein the at least one processor further determines at least one icon from the set of game icons which is matched by the player using the wild icon.

12. The electronic video game according to claim 9, wherein the at least one processor further determines at least one of a predetermined benefit and detriment to be imparted to the player if the at least one displayed icon is an icon from the set of special icons; and performs the at least one of the predetermined benefit and detriment.

13. The electronic video game according to claim 12, wherein the predetermined benefits and detriments are selected from the group consisting of doubling a player's winnings during a single round, negating any winnings during the single round, canceling any detriments to the player during the single round, and awarding a free round of play to the player.

14. The electronic video game according to claim 9, wherein the set of game icons and the set of matching icons are selected from the group consisting of a standard deck of playing cards.

15. The electronic video game according to claim 14, wherein the set of game icons and the set of matching icons each include aces, kings, queens, jacks and tens corresponding to the suits of diamonds, hearts, spades and clubs.

16. The electronic video game according to claim 15, wherein the step of determining a calculating a score includes the step of determining if the player matched three game icons of the same kind (three-of-a-kind); if the player matched four game icons of the same kind (four-of-a-kind); and if the player matched four game icons which include a ten, a jack, a queen, a king and an ace of the same suit.

17. A computer readable medium comprising a set of computer readable instructions capable of being executed by at least one processor for playing a game, the at least one processor performing the steps of:
displaying a set of game icons, each game icon being displayed by a corresponding position of a matrix;
displaying at least one of an icon from a set of matching icons matching the set of game icons and an icon from a set of special icons during each round of the game, said special icons imparting predetermined benefits and detriments to a player;
determining at least one of a matching condition and a special condition during play of each round, where said matching condition is determined if the at least one displayed icon is an icon from the set of matching icons and the at least one displayed icon is matched with a corresponding icon of the set of game icons by the player, and said special condition is determined if the at least one displayed icon is an icon from the set of special icons;
determining a winning condition if at least three icons from the set of game icons displayed by at least one of a row and column of the matrix are matched during play of a single round or a combination of rounds; and
calculating a score based on the determined winning condition.

18. The computer readable medium according to claim 17, wherein one of the icons of the set of special icons includes a wild icon for matching any displayed and unmatched icon from the set of game icons.

19. The computer readable medium according to claim 18, wherein the set of computer readable instructions are executed by the at least one processor for further performing the step of providing the player the opportunity to match a displayed icon from the set of game icons using the wild icon.

20. The computer readable medium according to claim 17, wherein the set of computer readable instructions are executed by the at least one processor for further performing the steps of:
determining at least one of a predetermined benefit and detriment to be imparted to the player if the at least one displayed icon is an icon from the set of special icons; and
performing the at least one of the predetermined benefit and detriment.

21. The computer readable medium according to claim 20, wherein the predetermined benefits and detriments are selected from the group consisting of doubling a player's winnings during a single round, negating any winnings during the single round, canceling any detriments to the player during the single round, and awarding a free round of play to the player.

22. The computer readable medium according to claim 17, wherein the set of game icons and the set of matching icons are selected from the group consisting of a standard deck of playing cards.

23. The computer readable medium according to claim 22, wherein the set of game icons and the set of matching icons each include aces, kings, queens, jacks and tens corresponding to the suits of diamonds, hearts, spades and clubs.

24. The computer readable medium according to claim 23, wherein the step of determining a calculating a score includes the step of determining if the player matched three game icons of the same kind (three-of-a-kind); if the player matched four game icons of the same kind (four-of-a-kind); and if the player matched four game icons which include a ten, a jack, a queen, a king and an ace of the same suit.
